(19) United States
(12) Patent Application Publication
(10) Pub. No.: US 2016/0339331 A1
(43) Pub. Date: Nov. 24, 2016

(54) Fully populated word matrix puzzle games for mobile devices

(71) Applicant: Gerald Seton McDonough, Minneapolis, MN (US)

(72) Inventor: Gerald Seton McDonough, Minneapolis, MN (US)

(21) Appl. No.: 15/155,021

(22) Filed: May 15, 2016

Related U.S. Application Data
(60) Provisional application No. 62/165,910, filed on May 23, 2015.

(51) Int. Cl. A63F 3/04; A63F 13/25; A63F 13/30; A63F 13/92

(52) U.S. Cl. CPC A63F 3/0421; A63F 13/92; A63F 13/25; A63F 13/30

(57) ABSTRACT

This invention defines a new type of word puzzle for play on mobile devices. This invention identifies 3 implementations of this type of puzzle. Mobile devices include, but are not restricted to, smart phones such as the Huawei Nexus 6P and tablets such as the Samsung Galaxy Tab S2. Game input is a set of words of the English language that, when stacked horizontally, also form words vertically. That is, the first character of each word forms a word, the second character of each word forms a word, and so on. In game play, the words have been partially constructed or scrambled, and the player's goal is to reassemble the underlying word matrix. Game play is designed for mobile devices using mobile device button taps. Game play is also explicitly designed to leverage mobile device landscape (long edge of device is horizontal) and portrait (long edge of device is vertical) modes. The rows of the word matrix in device landscape mode are the columns of the word matrix in device portrait mode. Player rotation of the mobile device between the modes transposes (rows rewritten as columns) the underlying word matrix, providing additional clues or perspective to the player. Players may rotate the device frequently while reassembling the word matrix, but that is not a requirement. When correctly reassembled, the player is presented links to retrieve word definitions from an online dictionary for all of the words in the word matrix.

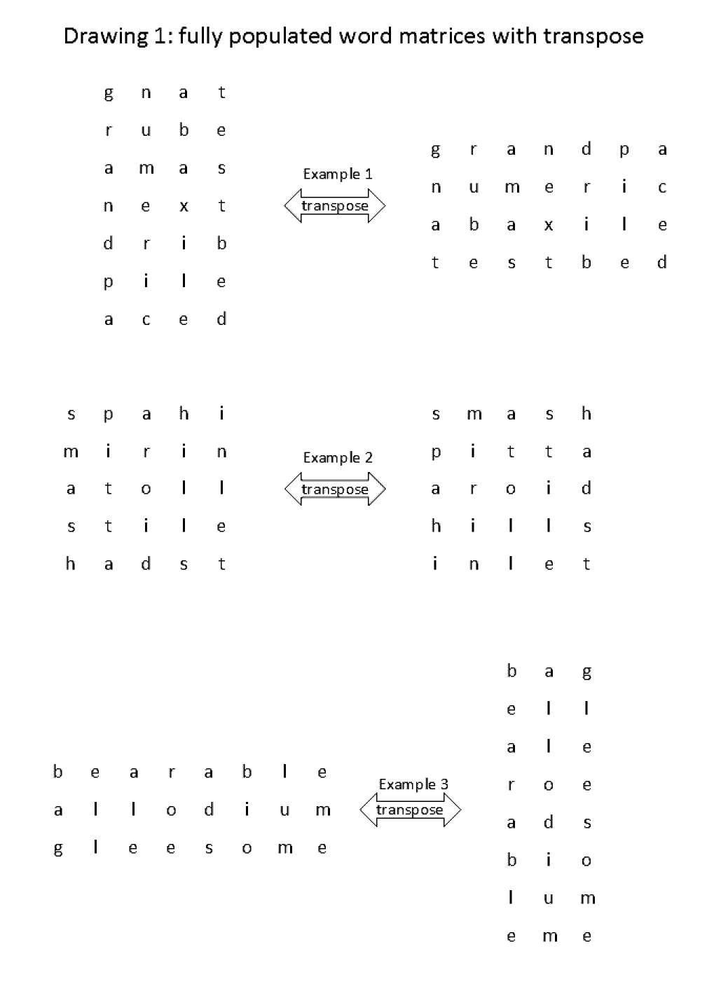

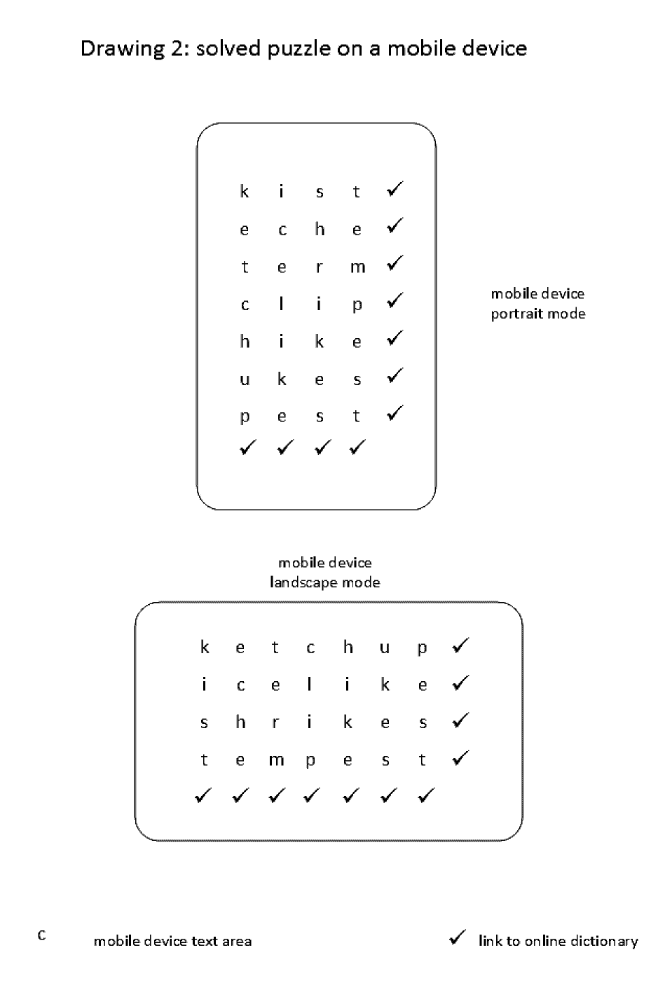

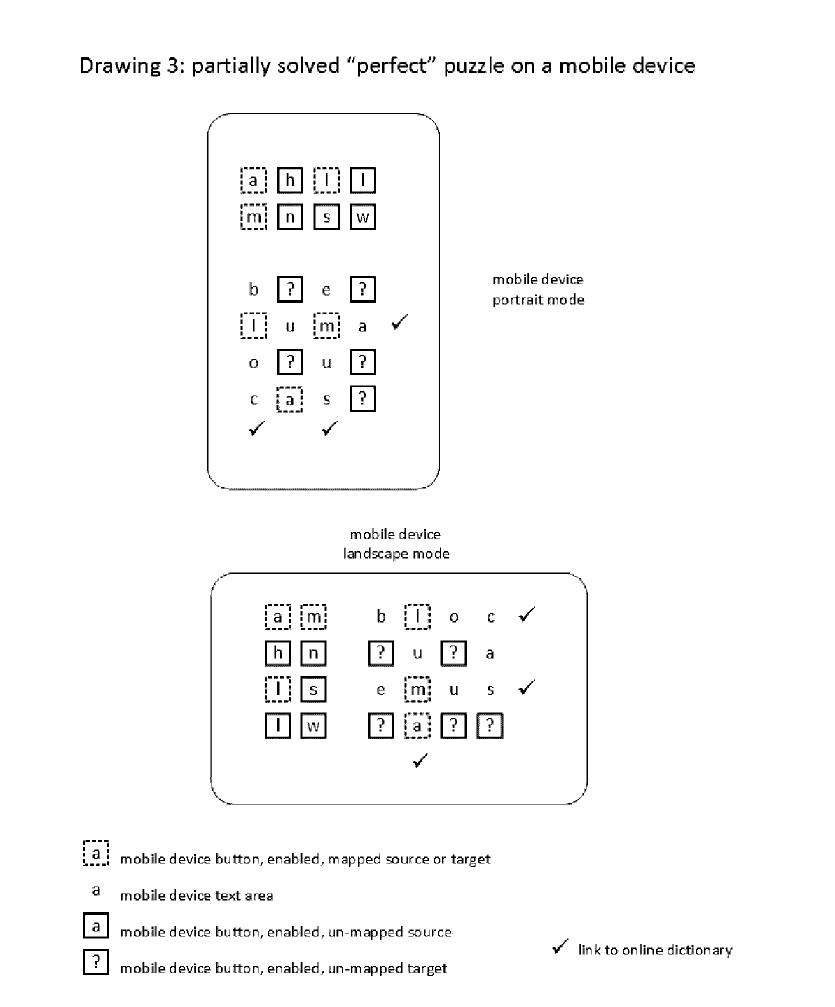

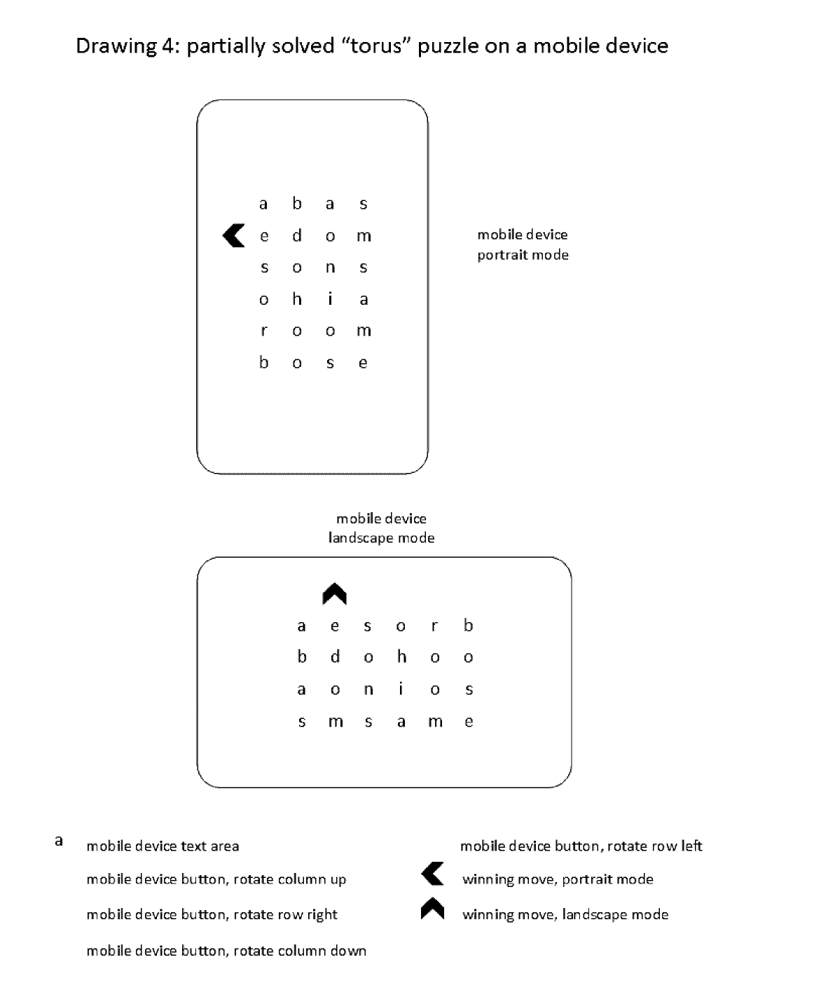

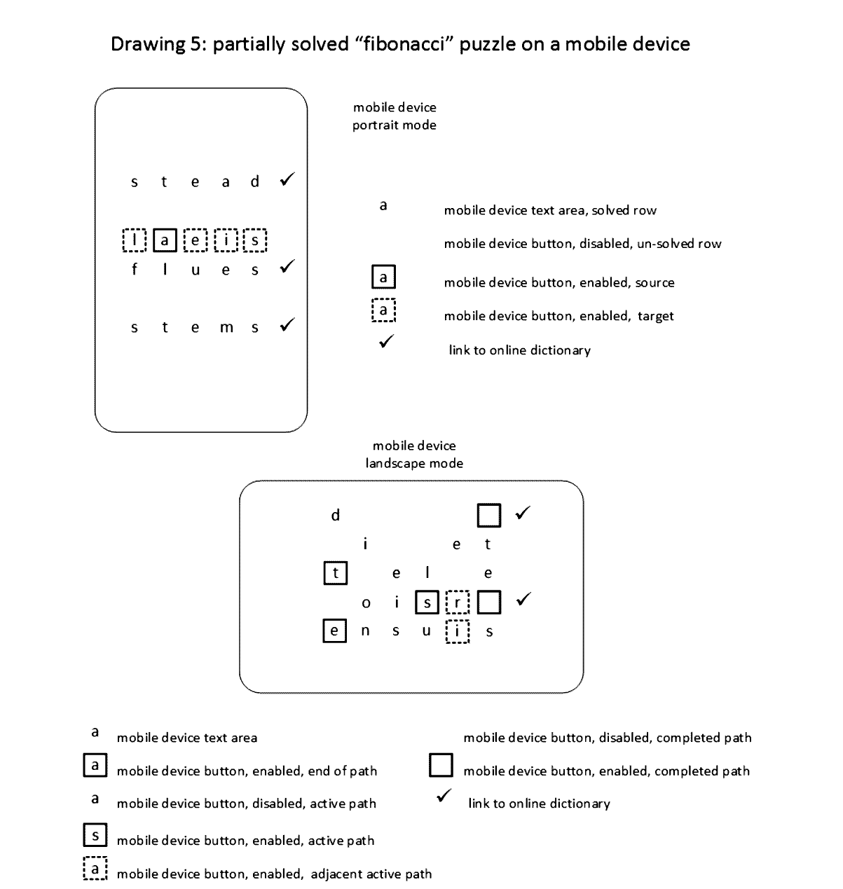

### BACKGROUND

A crossword puzzle is an example of a matrix based word game. Players add characters to cells (a matrix cell is the intersection of a row and column) in the matrix to complete words or phrases. However, the puzzle does not cover all cells within the matrix. It is not fully populated. Many characters within the puzzle belong to only a row or a column word or phrase, and many matrix cells contain no characters.

Sudoku is an example of a matrix based number game. Unlike crossword puzzles, all cells in the matrix must contain a number, and all cells are subject to multiple dependencies.

Neither of these puzzle types, as widely implemented on mobile devices, leverage the re-orientation capability of mobile devices. Device rotation does not produce a new perspective in to the puzzle. Implementations ignore device rotation or reproduce the puzzle without alteration.

### SUMMARY

This invention follows the Sudoku pattern of multiple dependencies for all matrix cells. In place of the numeric requirements, this invention places word requirements on the player. Each cell in the matrix must contain a character. Each character must contribute to a valid English language word horizontally across the matrix row and vertically along the matrix column.

This invention combines matrix transposition with mobile device rotation. The word matrix presented to the player with the mobile device in landscape mode is the transpose of the word matrix presented to the player in portrait mode, and vice versa.

Transposition is a key feature of game play. Players may recognize the puzzle solution more quickly in one of the modes. Frequent rotation of the device may also prove to be an assist, affording the player the opportunity to re-examine the word matrix with the additional information obtained from previous rotations.

### DRAWINGS

1. Fully populated word matrices with transpose (filename mcdonough.drawings.1.png)
   a. Example 1
      i. The transpose of a 7×4 matrix is a 4×7 matrix
      ii. Valid 4 character words: gnat, rube, amas, next, drib, pile, aced
      iii. Valid 7 character words: grandpa, numeric, abaxile, testbed
   b. Example 2
      i. The transpose of a 5×5 matrix is a 5×5 matrix
      ii. Valid 5 character words: spahi, mirin, atoll, stile, hadst
      iii. Other valid 5 character words: smash, pitta, aroid, hills, inlet
   c. Example 3
      i. The transpose of a 3×8 matrix is an 8×3 matrix
      ii. Valid 8 character words: bearable, allodium, gleesome
      iii. Valid 3 character words: bag, ell, ale, roe, ads, bio, lum, eme
2. Solved puzzle on a mobile device (filename mcdonough.drawings.2.png)
   a. A device is in portrait mode if its long edge is vertical
      i. Valid row words in portrait mode: kist, eche, term, clip, hike, ukes, pest
   b. A device is in landscape mode if its long edge is horizontal
      i. Valid row words in landscape mode: ketchup, icelike, shrikes, tempest
   c. Words are rendered on mobile device text areas, with each text area containing exactly 1 character.
   d. All characters belong to 2 valid words. For instance, the character “h” at portrait mode matrix (row, column) position (2, 3) is the 3^{rd} character of the word “eche” and the 2^{nd} character of the word “shrikes”.
   e. Checkmarks are links to an online dictionary
3. Partially solved “perfect” puzzle on a mobile device (filename mcdonough.drawings.3.png)
   a. Word matrix to solve is 4×4
   b. 8 characters in the puzzle are pre-filled
   c. 8 remaining unfilled characters are listed at the top (portrait mode) or on the side (landscape mode)
   d. Unfilled cells in the puzzle are marked with “?”
   e. Player goal is to correctly map unfilled characters to unfilled cells.
   f. Mapping is accomplished via a tap on an unfilled character followed by a tap on an unfilled cell.
   g. 3 of the puzzles 8 words have been correctly identified.
   h. Solution words (portrait): blew, luma, onus, cash
   i. Solution words (landscape): bloc, luna, emus, wash
4. Partially solved “torus” puzzle on a mobile device (filename mcdonough.drawings.4.png)
   a. Word matrix to solve is 6×4 (portrait mode), or 4×6 (landscape mode).
   b. Player goal is to un-scramble the word matrix via row and/or column rotations.
   c. Rotations triggered via button taps.
   d. The winning tap is highlighted.
      i. Rotation of the 2^{nd} row to the left in portrait mode.
      ii. Rotation of the 2^{nd} column upward in landscape mode.
   e. Solution words (portrait): abas, dome, sons, ohia, room, bose
   f. Solution words (landscape): adsorb, boohoo, amnios, sesame
5. Partially solved “fibonacci” puzzle on a mobile device (filename mcdonough.drawings.5.png)
   a. For this puzzle type, mechanics of play differ between portrait and landscape modes.
   b. Portrait mode play:
      i. The player works on 1 row at a time, interchanging character positions until the correct word is formed.
      ii. The last row is solved for the player.
      iii. In this example, the player has also solved the 1^{st} and 4^{th} rows.
      iv. The player is currently working on the 3^{rd} row.
         1. The player has currently selected the 2^{nd} column (the character “a”) via a mobile device button tap. This character is the “source”.
         2. Tapping on “1”, “e”, “i”, or “s” selects that character as the “target”.
         3. On “target” selection, the “source” and “target” are interchanged.
      v. The 2^{nd} and 5^{th} rows are inactive. Only 1 row may be worked at a time. If there is no active source, all buttons in all un-solved rows are active.
      vi. Solution: stead, hongi, aisle, flues, terai, stems
   c. Landscape mode play:
      i. The player constructs a path from left to right to form a valid English word.
      ii. Paths are built via mobile device button taps.
      iii. The player works on 1 path at a time, connecting a character from a column to an adjacent character in the next column. Adjacent characters are separated by 1 column and by at most 1 row.
   iv. The button at the end of a path is always enabled. This allows the player to switch between working paths. It also allows the player to undo a completed path. This may be necessary when path construction provides redundant choices to the player.
   v. The player has correctly identified the words “agleam” and “shafts”.
   vi. The player is working on the word d-i-e-s-?-?. “r” or “i” are the available choices for next character. “a” is also adjacent, but it has already been selected as the 5^{th} character of “agleam”.
   vii. Solution: shafts, toilet, ensure, agleam, diesis

### EMBODIMENTS

1. This invention has been implemented in the puzzle game known as “Words”.
2. This invention is played on mobile devices running the Android™ operating system.
3. This invention is available for free download at https://play.google.com/store/apps/details?id=mcd.words.actions
4. The fundamental data element of this invention is the fully populated word matrix.
   a. The word matrix may be rectangular. That is, the number of rows may be unequal to the number of columns.
   b. The word matrix may be square. That is, the number of rows may equal the number of columns.
   c. The “Words” puzzle game includes word matrices with the following dimensions (rows×columns): 3×3, 4×4, 5×4, 5×5, 6×6, 6×4, 7×4, 7×5, 8×3, and 8×4.
   d. Each row and each column in the word matrix form a valid English language word.
      i. Note: a word is considered valid if it is defined in at least 2 online dictionaries, including the dictionary at www.wiktionary.org.
   e. Each cell in the word matrix contains a character from the English alphabet.
   f. Each cell in the word matrix contributes to two words, one in the horizontal direction (from left to right) and one in the vertical direction (from top to bottom).
5. The Words game includes 3 different types of fully populated word matrix puzzle games:
   a. “perfect”
      i. This puzzle begins with a partially complete word matrix.
      ii. Each missing character from the word matrix is drawn on a mobile device button located outside of the word matrix.
      iii. Each missing cell in the word matrix is filled with a mobile device button labelled with the “?” character.
      iv. The player completes the puzzle by mapping the missing characters to their correct cell in the word matrix.
      v. Mapping is done by tapping on the missing character button, followed by tapping on the missing cell button.
      vi. The puzzle is complete when the player produces a fully populated word matrix by correctly mapping the missing characters.
   b. “torus”
      i. This puzzle begins with a matrix of characters that do not form valid words.
      ii. The puzzle includes buttons that, when tapped, result in a rotation of an individual row or column within the matrix.
         1. A row may be rotated to the left. Each character in the row is moved 1 cell to the left. The first character is moved to the last cell of the row.
         2. A row may be rotated to the right. Each character in the row is moved 1 cell to the right. The last character in the row is moved to the first cell of the row.
         3. A column may be rotated up. Each character in the column is moved 1 cell up. The first character in the column is moved to the last cell of the column.
         4. A column may be rotated down. Each character in the column is moved 1 cell down. The last character in the column is moved to the first cell of the column.
      iii. The puzzle is complete when the player produces a fully populated word matrix via the correct combination of row and column rotations.
   c. “fibonacci”
      i. This puzzle begins with a matrix of characters that do not form valid words.
      ii. Play mechanics for this puzzle differ between device portrait mode and device landscape mode.
      iii. portrait mode mechanics:
         1. The player rearranges characters within a row until a valid word is formed.
         2. The puzzle is complete when all rows have been correctly rearranged.
      iv. landscape mode mechanics:
         1. The player connects each character from a column to an adjacent character in the next column.
         2. For a character in cell position (i, j), adjacent characters are in cell positions (i+1, j+1), (i, j+1), (i−1, j+1).
         3. The connected characters form a path through the matrix.
         4. The connected characters should form a valid word.
         5. The number of paths is equal to the number of rows.
         6. The puzzle is complete when all paths have been correctly constructed.

1. A method for playing a word puzzle game on mobile devices comprising:
a. Game play that begins with a scrambled or partially completed fully populated word matrix.
b. Game play with the goal of completing or re-creating the underlying fully populated word matrix.
c. Direct association between mobile device orientation and word matrix orientation, whereby device rotation triggers matrix transposition.

2. This method of game play as implemented in the “perfect” puzzle type in the “Words” puzzle game.

3. This method of game play as implemented in the “fibonacci” puzzle type in the “Words” puzzle game.

4. This method of game play as implemented in the “torus” puzzle type in the “Words” puzzle game.
